(19) United States
(12) Patent Application Publication
(10) Pub. No.: US 2023/0140571 A1
(43) Pub. Date: May 4, 2023

(54) HEATED STROLLER

(71) Applicant: Douet Olivene Lyn, Silver Spring, MD (US)

(72) Inventor: Douet Olivene Lyn, Silver Spring, MD (US)

(21) Appl. No.: 17/452,645

(22) Filed: Oct. 28, 2021

(51) Int. Cl. B62B 9/10; B62B 9/14; B62B 7/06

(52) U.S. Cl. CPC B62B 9/10; B62B 7/06; B62B 9/142

(57) ABSTRACT

A heated stroller provides a warm environment for a child or infant. The heated stroller includes a heating pad that is carried with a carriage, providing an enclosure for containing the child or infant. A cover may be coupled with the carriage to define an enclosed space. A control panel is operable to control the heating pad and is connected with a battery, which may be carried with the carriage. A frame assembly, supported by wheels, may be provided for supporting the carriage as a stroller. The frame assembly includes an upright handle that allows a user of the heated stroller to control the stroller. The frame assembly may be foldable to compact the stroller for transport in a vehicle, or storage.

### BACKGROUND OF THE INVENTION

The present invention relates to strollers, and more particularly to protecting an child or infant occupant of the stroller from cold temperatures.

Taking the bus, train, or walking with a baby on a cold winter morning can be a major inconvenience because a parent or a caregiver has to bundle the baby. Babies don’t always want to be bundled because it is restrictive and not effective for exposed areas of the skin. Even with bundling, in a conventional stroller, the babies are still subjected to the cold weather environment.

As can be seen, there is a need for improved stroller for cold weather environments.

### SUMMARY OF THE INVENTION

In one aspect of the present invention, a heated infant and child carrying device is disclosed. The heated infant and child carrying device includes a carriage having at least one sidewall defining a bottom enclosure defining an interior space dimensioned to contain an infant or a child. An opening at a top of the carriage is dimensioned for inserting and retrieving an infant or a child from the bottom enclosure. A heating pad is carried in a lower end of the bottom enclosure. A control panel is operable with the carriage to control a thermal output of the heating pad.

In other aspects of the invention, a heated infant and child carrying device includes a carriage having at least one sidewall defining a bottom enclosure. The bottom enclosure defines an interior space dimensioned to contain an infant or a child. An opening at a top of the carriage is dimensioned for inserting and retrieving an infant or a child from the bottom enclosure. A heating pad is carried in a lower end of the bottom enclosure. A frame assembly is coupled with the carriage and has a plurality of wheels for movably supporting the frame and the carriage. An upright handle extends from the frame assembly for controlling a movement of the frame assembly. A control panel is connected to the frame assembly to control a thermal output of the heating pad.

These and other features, aspects and advantages of the present invention will become better understood with reference to the following drawings, description and claims.

### BRIEF DESCRIPTION OF THE DRAWINGS

FIG. 1 is a front perspective view of the heated stroller in use.

FIG. 2 is an exploded perspective view of the heated stroller.

FIG. 3 is a detail plan view of a control panel for the heated stroller.

FIG. 4 is a detail schematic view of the heating system for the heated stroller.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a heated stroller to protect child and infant occupants from cold temperatures.

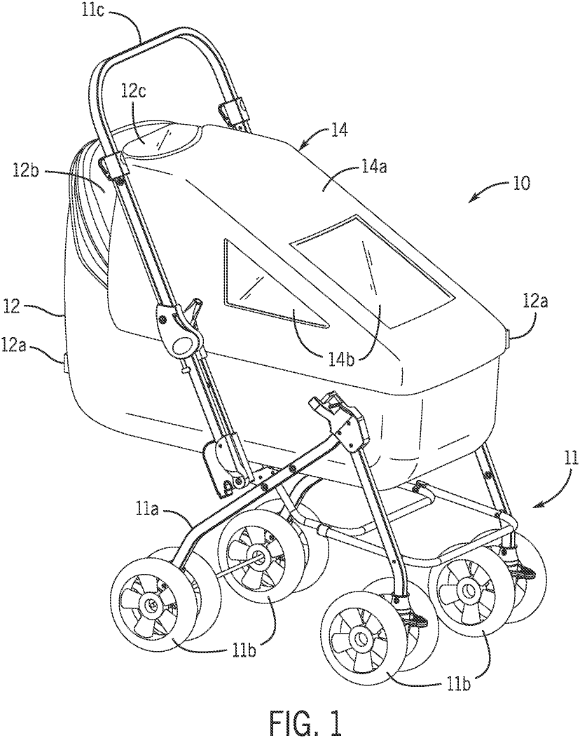

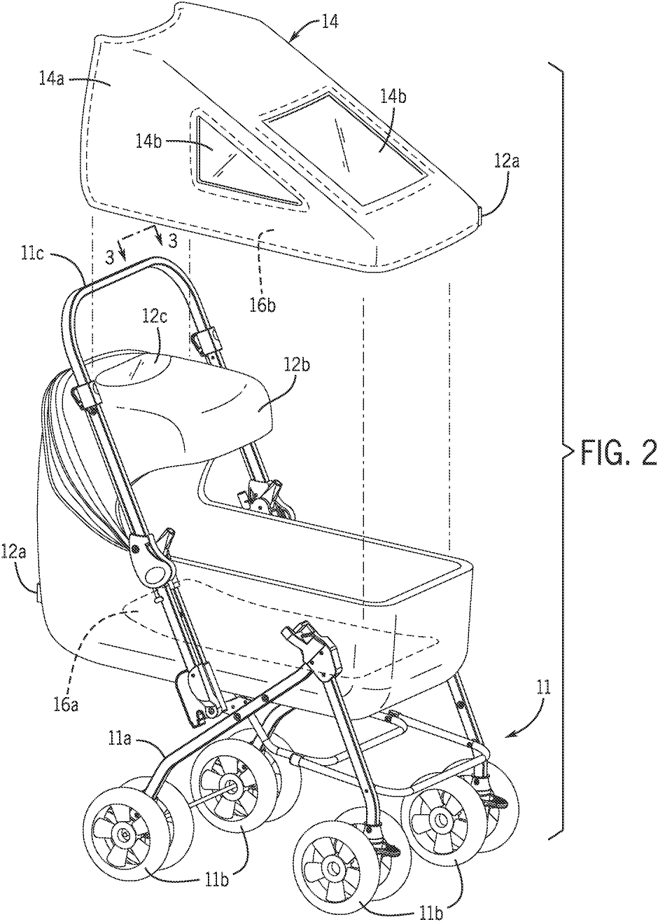

A non-limiting embodiment of a heated stroller is shown in reference to FIGS. 1 and 2. The heated stroller 10 includes a stroller 11 having a frame assembly 11a that is carried on a plurality of wheels 11b. An upright handle 11c of the frame assembly 11a allows a user of the heated stroller 10 to control the stroller 11. The frame assembly 11a may be foldable to compact the stroller 10 for transport in a vehicle, or storage.

A carriage 12 is mounted to the frame assembly 11a. The carriage 12 has at least one sidewall defining a bottom enclosure or basket for containing a child or an infant occupant of the heated stroller 10. More typically, the carriage 12 will have a bottom wall and at least one sidewall, with an opening at a top thereof for inserting and retrieving an occupant from the carriage. The carriage 12 may include one or more outlets 12a for connecting a power source to the stroller 10. A collapsible shade 12b may be provided and is movable between a stowed condition and a deployed position. In the deployed position the collapsible shade 12b partially protects the occupant from the elements, such as sun, wind, and precipitation. The collapsible shade 12b may also include a window 12c formed of a transparent material so that the user is provided visibility of the occupant when the collapsible shade 12b is in the extended position.

A cover 14 is provided to enclose the carriage 12. The cover 14 may be formed of a fabric material 14a and may be coupled with the carriage 12 via a plurality of fasteners, such as snaps, buttons, hook and pile fasteners, or an elastic-bands. As with the collapsible shade 12b, the cover 14 may include one or more windows 14b so that the occupant may see outside the enclosed space within the cover 14 and the carriage 12. The cover 14 may be configured to enclose the carriage 12 with or with the collapsible shade 12b in either of the stowed or deployed position. The cover 14 may also be configured to enclose a carriage 12 without a collapsible shade 12b.

As seen in reference to FIG. 2, a primary heating pad 16a is provided to warm the enclosed space of the carriage 12 and the cover 14. Preferably, the heating pad 16a is positioned at a bottom surface of the carriage 12 so that warmth generated by the primary heating pad 16a may rise and warm the occupant and the interior space of the carriage 12. Typically, a padding layer, not shown, is provided to cushion the occupant and protect the primary heating pad 16. As will be appreciated, at milder temperatures, the primary heating pad 16a may provide warmth to the occupant, with or without the collapsible shade 12b deployed or the cover 14 installed. With the cover 14 installed, the warmth may be retained within the cover 14 and the bottom enclosure.

With more frigid temperatures, higher wind speeds, and precipitation conditions, the primary heating pad 16b is supplemented with a secondary heating pad 16b, incorporated with the cover 14. The secondary heating pad 16 may also be carried with the cover 14 to limit frost accumulation on the interior of the cover 14 and the one or more window panels and to provide a better distribution of heat within the enclosed space.

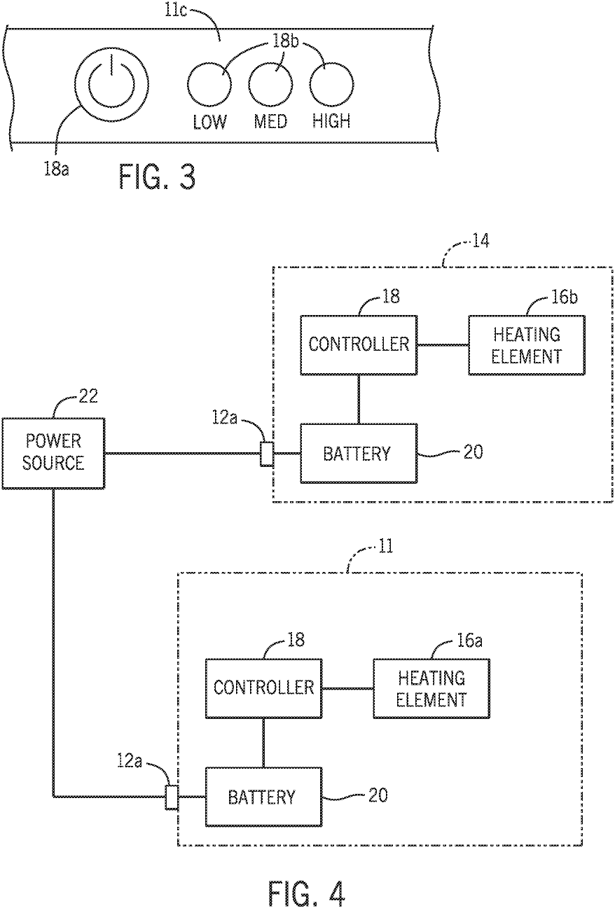

As seen in reference to FIGS. 3 and 4, a control panel 11c may be coupled with the heated stroller 10, to one of the frame assembly 11a, the handle 11b, or the carriage 12. The control panel 11c may have one or more controls 18b for regulating the output of the primary heating pad 16a, the secondary heating pad 16b and the heat delivered to the carriage 12. The controller 18 is operably connected with a battery 20 that is carried with the heated stroller 10. The battery 20 is preferably a rechargeable battery which may be replenished by connection with a power source 22, such as a charger connected with an electrical power, such as an electrical outlet in a home or dwelling, a motor vehicle, or a solar panel.

In operation, the user may activate the one or more controls 18b to supply power to the heating pad 16. The user may place the occupant within the carriage 12. The cover 14 may be installed to enclose the carriage 12. The user may regulate a temperature of the enclosed space by operation of the one or more controls. The user may also connect the battery 20 with a power source in use or to replenish the battery 20.

While shown in use with a stroller frame 11a, heating system of the present invention may also be incorporated with the carriage 12 and be utilized when the carriage 12 is separated from the frame assembly 11c, such as with convertible car carrier and stroller combinations. In this case, the carriage 12 may be utilized to provide a warm environment for the occupant without the frame assembly 11c.

With the present invention, people with children, who don’t have access to an automobile and need to go to school or work by bus or train, would be able to use the heated stroller 10 and cover 14 with the peace of mind knowing their babies are comfortable and maybe even sleep as they travel to their destination. Going to a game or on some adventure would also allow for more outdoor time, for the child and parents alike.

It should be understood, of course, that the foregoing relates to exemplary embodiments of the invention and that modifications may be made without departing from the spirit and scope of the invention as set forth in the following claims.

What is claimed is:

1. A heated infant and child carrying device, comprising:
a carriage having at least one sidewall defining a bottom enclosure, the bottom enclosure defining an interior space dimensioned to contain an infant or a child; an opening at a top of the carriage dimensioned for inserting and retrieving an infant or a child from the bottom enclosure;
a heating pad carried in a lower end of the bottom enclosure; and
a control panel operable with the carriage to control a thermal output of the heating pad.

2. The heated infant and child carrying device of claim 1, further comprising:
a battery coupled with the control panel.

3. The heated infant and child carrying device of claim 1, further comprising:
a frame assembly configured to couple with the carriage and support the carriage in an occupant transport orientation;
a plurality of wheels supporting the frame assembly; and
an upright handle extending from the frame assembly.

4. The heated infant and child carrying device of claim 3, wherein the frame assembly is foldable.

5. The heated infant and child carrying device of claim 4, further comprising:
a collapsible shade coupled with the carriage, the collapsible shade moveable between a stowed position and a deployed condition, wherein in the deployed condition, the collapsible shield provides at least partial protection from environmental conditions above the opening.

6. The heated infant and child carrying device of claim 1, further comprising:
a cover removably connected with the carriage and dimensioned to enclose the opening of the carriage.

7. The heated infant and child carrying device of claim 6, further comprising:
an additional heating pad coupled with the cover and operable by the control panel.

8. A heated infant and child carrying device, comprising:
a carriage having at least one sidewall defining a bottom enclosure, the bottom enclosure defining an interior space dimensioned to contain an infant or a child; an opening at a top of the carriage dimensioned for inserting and retrieving an infant or a child from the bottom enclosure;
a heating pad carried in a lower end of the bottom enclosure;
a frame assembly coupled with the carriage, the frame assembly having a plurality of wheels for movably supporting the frame and the carriage, and an upright handle extending from the frame assembly for controlling a movement of the frame assembly; and
a control panel connected to the frame assembly to control a thermal output of the heating pad.

9. The heated infant and child carrying device of claim 8, further comprising:
a cover removably connected with the carriage and dimensioned to enclose the opening of the carriage.

10. The heated infant and child carrying device of claim 9, further comprising:
an additional heating pad coupled with the cover and operable by the control panel.

11. The heated infant and child carrying device of claim 9, further comprising:
a battery connected with the control panel to power the heating pad.
